(19) United States
(12) Patent Application Publication
(10) Pub. No.: US 2026/0046470 A1
(43) Pub. Date: Feb. 12, 2026

(54) MULTI-SOURCE MULTIMEDIA OUTPUT AND SYNCHRONIZATION

(71) Applicant: QUALCOMM Incorporated, San Diego, CA (US)

(72) Inventors: Jason FILOS, Newark, NJ (US); Benjamin LUND, Escondido, CA (US); Edwin Chongwoo PARK, San Diego, CA (US); Bala RAMASAMY, San Marcos, CA (US); Danlu ZHANG, San Diego, CA (US); Wesley James HOLLAND, Encinitas, CA (US)

(21) Appl. No.: 19/103,015

(22) PCT Filed: Aug. 1, 2023
(86) PCT No.: PCT/US2023/029171

§ 371 Date: Feb. 11, 2025

(30) Foreign Application Priority Data
Sep. 22, 2022 (GR) 20220100777

(51) Int. Cl. H04N 21/43; G06F 3/01

(52) U.S. Cl. CPC H04N 21/43072; G06F 3/013; G06F 3/017

(57) ABSTRACT

Various embodiments may include a method for multi-source multimedia output and synchronization in a computing device. The method may include receiving a user input selecting one of an audio component, video component, or other perceivable media component associated with multimedia content being rendered by a remote media player within in a perceptible distance of a user of the computing device. The user input indicates that the user wants the selected audio component, video component, or other perceivable media component rendered on the computing device. The method also identifies the multimedia content and obtains the identified multimedia content from a source of the multimedia content. The method also renders the selected one of the audio component, video component, or other perceivable media component from the obtained multimedia content, by the computing device, synchronized with the rendering by the remote media player within the perceptible distance of the user.

### RELATED APPLICATIONS

This application claims the benefit of priority from Greek Patent Application No. 20220100777, filed Sep. 22, 2022; the entire contents of which is herein incorporated by reference.

### BACKGROUND

Presentations of multimedia content has become ubiquitous on media players deployed in many bars, restaurants, gyms, airports, event venues, homes, and other private and/or public places. However, the ability of a perceive to both audio and video components of the multimedia content being rendered is often limited. For example, although monitors displaying different multimedia content can be found in bars, often ambient noises mean people can see the video but cannot hear the audio.

Whether it is the proximity to media player's speakers, the ambient noise in the area, or a combination thereof, the people are frequently limited to only watching without listening to the multimedia content. In situations where there are multiple monitors streaming different content, only the video component of the respective multimedia contents is generally rendered, which means the consumer has no way of hearing the audio component intended to accompany the rendered video component. In addition, venues like bars or sports betting establishments sometimes provide only speakers that broadcast the audio component of multimedia content, like races or sporting events, leaving listeners to imagine what the events look like. Consumers could benefit from enhanced reality (XR) devices configured to provide multi-source multimedia output and synchronization.

### SUMMARY

Various aspects of the present disclosure include methods, systems, and devices for rendering an audio component, video component, or other perceivable media components of a multimedia stream being rendered on a remote multimedia device in a manner that can be perceived by a user, such as on computing devices or more particularly enhanced reality (XR) devices, synchronized with the multimedia stream. Various aspects may include a method for multi-source multimedia output and synchronization in a computing device. The method may include receiving a user input selecting one of an audio component, video component, or other perceivable media component associated with multimedia content being rendered by a remote media player within in a perceptible distance of a user of the computing device. The user input indicates that the user wants the selected audio component, video component, or other perceivable media component rendered on the computing device. The method also identifies the multimedia content and obtains the identified multimedia content from a source of the multimedia content. The method also renders the selected one of the audio component video component, or other perceivable media component from the obtained multimedia content, by the computing device, synchronized with the rendering by the remote media player within the perceptible distance of the user.

In some aspects, the multimedia content may be selected by the user from a plurality of multimedia content observable by the user. In some aspects, receiving a user input may include detecting a gesture performed by the user, interpreting the detected gesture to determine whether it identifies the multimedia content being rendered within a threshold distance of the computing device, and identifying one of the audio component, video component, or other perceivable media component of the identified multimedia content that the user wants rendered on the computing device.

In some aspects, identifying the multimedia content that is being rendered on a display within a perceptible distance of the user of the computing device may include detecting a gaze direction of the user and identifying the multimedia content that is being rendered on the display in the direction of the user's gaze.

In some aspects, identifying multimedia content that is being rendered on the display within a perceptible distance of a user of the computing device may include receiving a user input indicating a direction from which the user is perceiving the multimedia content and identifying the multimedia content based on the received user input.

In some aspects, obtaining the identified audio component, video component, or other perceivable media component of the multimedia content from a source of the multimedia content may include obtaining metadata regarding the multimedia content; using the obtained metadata to identify a source of the multimedia content, and obtaining the audio component, video component, or other perceivable media component from the identified source of the multimedia content.

In some aspects, obtaining the identified audio component, video component, or other perceivable media component of the multimedia content from a source of the multimedia content may include transmitting a query to a remote computing device regarding the multimedia content, requesting identification of a source of the multimedia content, and obtaining the audio component, video component, or other perceivable media component from the identified source of the multimedia content.

Some aspects may include sampling one of the audio component or video component being rendered by the remote media player. The transmitted query may include at least a portion of the sampled one of the audio component or video component. At least one of the identification of the source of the multimedia content or synchronization with the rendering by the remote media player may be based on information received in response to the transmitted query.

In some aspects, obtaining the identified multimedia content from a source of the multimedia content may include obtaining subscription access to the multimedia content from the source of the multimedia content and receiving the identified audio component, video component, or other perceivable media component of the multimedia content based on the obtained subscription access.

In some aspects, rendering the selected one of the audio component, video component, or other perceivable media component, by the computing device, synchronized with the rendering by the remote media player within in the perceptible distance of the user may include sampling one or more of the audio component, video component, or other perceivable media component of the multimedia content being rendered by the remote media player within the perceptible distance of the user.

Additionally, a timing difference may be determined between samples of one or more of the audio component, video component, or other perceivable media component of the multimedia content being rendered and the audio component, video component, or other perceivable media component obtained from the source of the multimedia content. Also, the selected one of the audio component, video component, or other perceivable media component may be rendered by the computing device so that the user will perceive the selected one of the audio component, video component, or other perceivable media component so rendered to be synchronized with the multimedia content rendered by the remote media player.

In some aspects, the computing device may be an enhanced reality (XR) device.

Further aspects include a computing device configured with a processor for performing one or more operations of any of the methods summarized above. Further aspects may include a non-transitory processor-readable storage medium having stored thereon processor-executable instructions configured to cause a processor of a computing device to perform operations of any of the methods summarized above.

Further aspects include a computing device having means for performing functions of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1A is a component block diagram of a multi-source multimedia environment suitable for implementing various embodiments.

FIG. 1B is a component block diagram of another multi-source multimedia environment suitable for implementing various embodiments.

FIG. 1C is a component block diagram of another multi-source multimedia environment suitable for implementing various embodiments.

FIG. 1D is a component block diagram of another multi-source multimedia environment suitable for implementing various embodiments.

FIG. 2A is a schematic diagram of a gesture-based user input technique suitable for implementing various embodiments.

FIG. 2B is a schematic diagram of a gaze-based user input technique 201 suitable for implementing various embodiments.

FIG. 2C is a schematic diagram of a screen-based user input technique 202 suitable for implementing various embodiments.

FIG. 2D is a schematic diagram of another screen-based user input technique 203 suitable for implementing various embodiments.

FIG. 2E is a schematic diagram of another XR overlay-based user input technique 204 suitable for implementing various embodiments.

FIG. 3 is a component block diagram illustrating an example computing and wireless modem system on a chip suitable for use in a computing device implementing any of the various embodiments.

FIG. 4A is a communication flow diagram illustrating a method for multi-source multimedia output and synchronization in a computing device according to various embodiments.

FIG. 4B is a communication flow diagram illustrating an example method 401 for multi-source multimedia output and synchronization in a computing device according to various embodiments.

FIG. 5A is a process flow diagram illustrating a method for multi-source multimedia output and synchronization in a computing device, in accordance with various embodiments.

FIG. 5B is a process flow diagram illustrating additional operations that the processor of the computing Device may perform, in accordance with various embodiments.

FIG. 6 is a component block diagram of a user mobile device suitable for use with various embodiments.

FIG. 7 is a component block diagram of an example of smart glasses suitable for use with various embodiments.

FIG. 8 is a component block diagram of a server suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments provide user device (e.g., a computing device) that is configured to receive a user input requesting rendering on the user device of an audio component, video component, or other perceivable media component of multimedia content streams being rendered on nearby media players, detect and identify the multimedia content, obtain the requested component of the multimedia content from a source of the multimedia content, and render the selected audio component, video component, or other perceivable media component from the obtained multimedia content in a manner that is synchronized with the multimedia content being rendered. Various embodiment enable a user who can see but not hear, hear but not see, feel but not hear, or feel but not see multimedia being rendered nearby to receive the audio component, video component, or other perceivable media component in the user's mobile device, such as an XR device. Various embodiments include user-interaction methods enabling the user to identify the multimedia content that is desired to be heard, seen, or felt on the user's mobile device.

In overview, various embodiments may include receiving a user input selecting one of an audio component, video component, or other perceivable media component associated with multimedia content being rendered by a remote media player within in a perceptible distance of a user of the computing device. The user input may indicate that the user wants the selected audio component, video component, or other perceivable media component to be rendered on the computing device. The method may also include identifying the multimedia content and obtaining the identified multimedia content from a source of the multimedia content. In addition, the selected one of the audio component, video component, or other perceivable media component may be rendered from the obtained multimedia content, by the computing device, synchronized with the rendering by the remote media player within the perceptible distance of the user.

One solution for venues with numerous monitors that display different and varied multimedia content, is to provide systems with separated audio and video components, such as wireless device (e.g., earphones or mobile video players) that can receive media from a local network. Such separated audio/video systems may allow customers to select from different stations or channels that broadcast the audio component of the multimedia content (e.g., via a wireless router) at the same time that the video component is displayed on a separate monitor. Such separated audio/video systems do not need to identify the multimedia content that is playing because the local wireless network or preset stations or channels make content identification unnecessary. Also, the speakers or media players receiving the broadcast on the preset stations or channels just output the audio stream as it is received. Thus, there is no need or ability to perform synchronization of the audio output because only the audio component of the separated audio/video components is received by that equipment. In addition, the separated audio/video components prevent the use of many enhanced features for computing devices used in conjunction with the multimedia content, such as haptic feedback, augmented reality, enhanced reality overlays, and the like. Further, such separated audio/video systems require custom on-site hardware that demultiplexes the multimedia content and transmits the audio and video components separately. In addition, such separated audio/video systems are limited to particular venues equipped with such capabilities.

Various embodiments provide solutions for situations in which a user of a mobile device, such as an XR device, may not be able to hear the audio component of multimedia content being rendered on a nearby remote display. In particular, the computing device may detect a multimedia content stream on one or more nearby devices and identify or recognize the multimedia content. Once the multimedia content is identified, the computing device may obtain its own copy of the multimedia content stream and provide a user of the computing device with dynamically synchronized audio and video components of the multimedia content. The multimedia stream in question may be a live broadcast (e.g., sports, news, etc.), a scheduled program (e.g., major television broadcast), or an on-demand playback (e.g., Netflix, YouTube, Amazon Video, etc.).

As used herein, the term “computing device” refers to an electronic device equipped with at least a processor, memory, and a device for presenting output such as audio/video components of multimedia content. In some embodiments, a computing device may include wireless communication devices such as a transceiver and antenna configured to communicate with wireless communication networks. A computing device may include any one or all of augmented/virtual reality devices, cellular telephones, smartphones, portable computing devices, personal or mobile multimedia players, laptop computers, tablet computers, 2-in-1 laptop/table computers, smart books, ultrabooks, multimedia Internet-enabled cellular telephones, entertainment devices (e.g., wireless gaming controllers, music and video players, satellite radios, etc.), smart rings, smart necklaces, smart glasses, smart contact lenses, contactless sleep tracking devices, smart furniture such as a smart bed or smart sofa, smart exercise equipment, Internet of Things (IoT) devices, and similar electronic devices that include a memory, wireless communication components and a programmable processor. In some embodiments, a computing device may be wearable device by a person. As used herein, the term “smart” in conjunction with a device, refers to a device that includes a processor for automatic operation, for collecting and/or processing of data, and/or may be programmed to perform all or a portion of the operations described with regard to various embodiments.

The terms “enhance reality device” or “XR device” are used herein interchangeably to refer to one or more mobile computing devices configured to allow a user of the XR device to experience augmented reality (AR), virtual reality (VR), mixed reality (MR), and everything in between. An XR device may be a single unitary electronic device or a combination of separate electronic devices. For example, a single electronic device forming an XR device may include and combine functionality from a smartphone, mobile VR headset, and AR glasses into a single XR wearable. Alternatively, one or more of a smartphone, mobile VR headset, AR glasses, and/or other computing devices may work together as separate devices that collectively may be considered an XR device according to various embodiments.

The term “multimedia content” is used herein to refer to the content of communications observable by a user of a VR device that may combine different content forms such as text, audio, images, animations, video, and/or other elements into a single interactive presentation, in contrast to traditional mass media, such as printed material or audio recordings, which features little to no interaction between users. For example, multimedia content may include videos that comprise both audio and video components, audio slideshows, animated videos, and/or other audio and/or video presentations that may include haptic feedback, augmented reality (AR) elements, extended reality (ER) overlays, MR overlays, and the like. Multimedia content may be recorded for playback (i.e., rendering) on computers, laptops, smartphones, and other computing or electronic devices, either on demand or in real time (streaming).

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single computing device. The proximity of the SOCs facilitates high speed communications and the sharing of memory and resources.

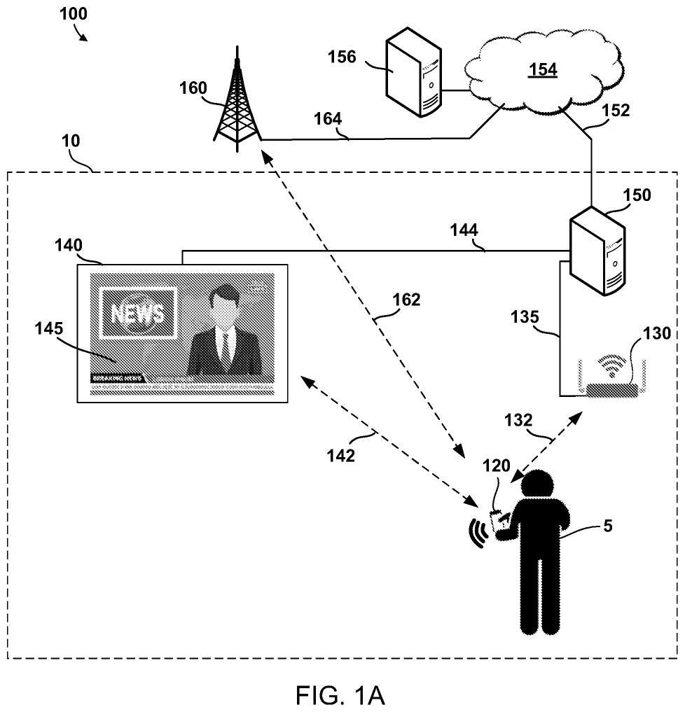

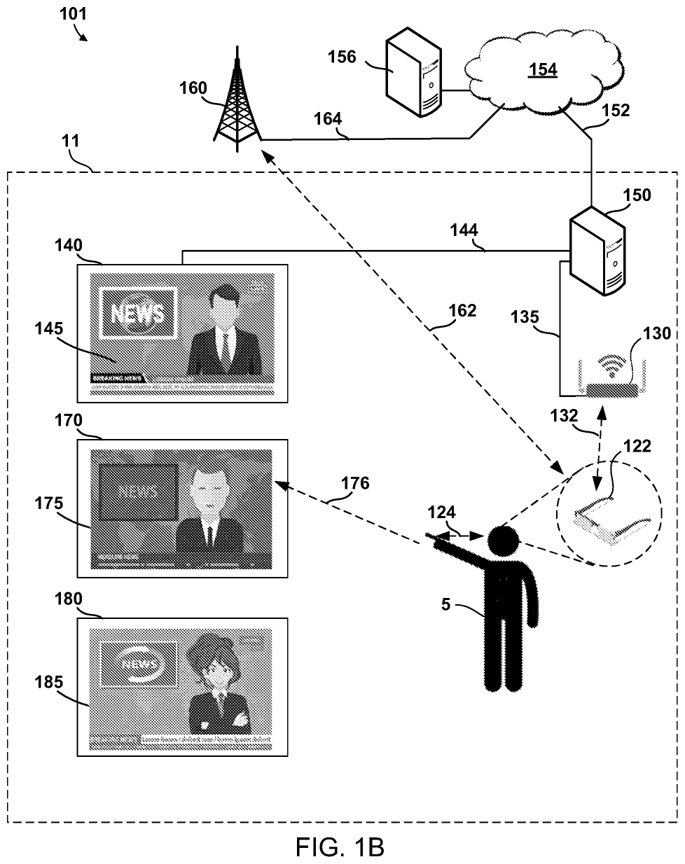

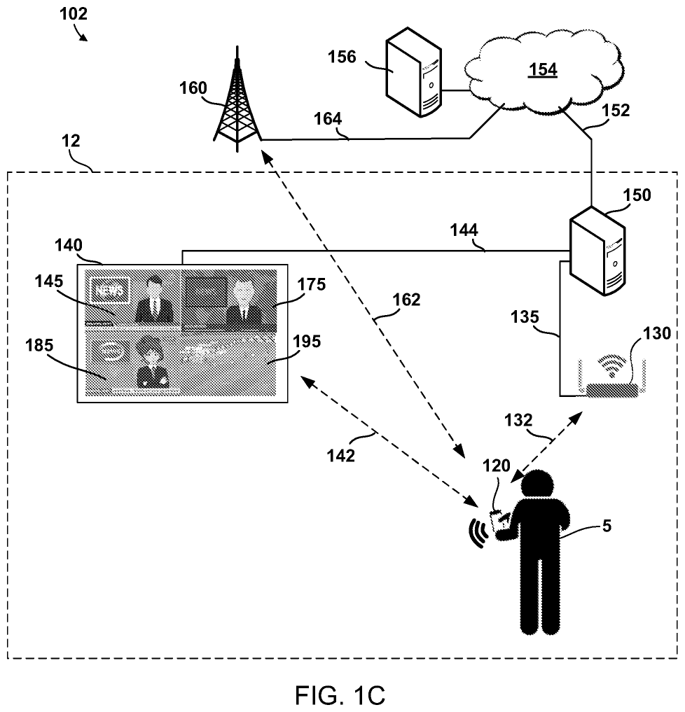

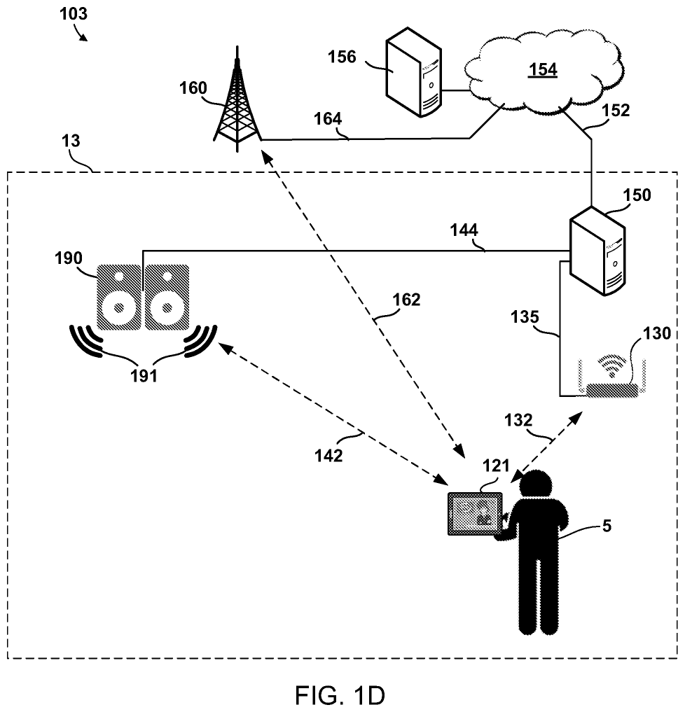

FIG. 1A is a component block diagram of a multi-source multimedia environment 100 suitable for implementing various embodiments. The multi-source multimedia environment 100 may include a computing device 120 in the form of a smartphone configured to receive inputs from a user 5, particularly associated with selections related to multimedia content. The computing device 120 could alternatively be a different form of computing device, such as smart glasses or the like, or comprise more than one computing device working together. In the environment 100, the user 5 is equipped with the computing device 120 and has arrived at a venue 10 that includes a remote media player 140 in the form of a television. For example, the venue 10 could be a bar, restaurant, gym, airport, event venue, or the like. The remote media player 140 is playing (i.e., rendering) a first multimedia content 145 (e.g., a live news stream) and may be configured to stream different multimedia content.

In accordance with various embodiments, the remote media player 140 may be playing at least part of the first multimedia content 145 by rendering a video component thereof on a display. The remote media player 140 may optionally also be rendering an audio component of the first multimedia content 145 from one or more speakers. However, the user 5 may want one of the audio component, video component, or other perceivable media component of the first multimedia content 145 to be played through the computing device 120. For example, although the user 5 may be able to see the display on the remote media player 140, with the corresponding video component of the first multimedia content 145 thereon, the user 5 may not be able to hear the audio component. Thus, desiring to hear the audio component of the first multimedia content 145, in accordance with various embodiments the user 5 may obtain the audio component and have it rendered by the computing device 120.

By providing a user input on the computing device 120, the user 5 may initiate the process of obtaining the audio component of the first multimedia content 145. For example, by aiming a camera on the computing device 120 at the remote media player 140 and focusing on the first multimedia content 145, the computing device 120 may receive a user input (e.g., in the form of a sampling image) indicating the content that the user 5 wants rendered. The user input may be used to determine the media content that is selected by the user 5 for rendering that content. With the desired content (e.g., the audio component) rendered by the computing device 120 in synch with the rendering of the video component on the remote media player 140, the user 5 may have a more enjoyable experience observing and taking in the first multimedia content 145.

Alternatively, although the user 5 may be able to hear the sound from the audio component of the first multimedia content 145, emitted by speakers of the remote media player 140 or even other remote speakers in the venue 10, the user 5 may not be able to see the video component thereof (e.g., due to crowding in the venue 10 or a direction in which the user is seated that does not face the display). Thus, desiring to see the video component of the first multimedia content 145, in accordance with various embodiments the user 5 may obtain the video component and . it rendered by the computing device 120. With the video component rendered by the computing device 120 in synch with the rendering of the audio component from the remote media player 140, the user 5 may have a more enjoyable experience listening to and observing the first multimedia content 145.

In some embodiments, although the user 5 may be able to see the video component and/or hear the audio component, rendered by the remote media player 140, the user 5 may want to perceive other media components, such as haptic feedback, captions, translations, sign languages, or other overlays. For example, haptic seat/chair, clothing, watch, speakers (e.g., a subwoofer), etc. may be configured to provide the user with an additional perceivable component that is part of the source multimedia content. In some embodiments, lights may be configured to flash, dim, or brighten, in coordination with the source multimedia content. The user may want to receive captions, translations, sign language, or other overlays locally on the user's computing device 120.

In some embodiments, the user 5 may not want to hear the audio component or may not want to hear the audio any louder but could benefit from feeling haptic sensations associated with the content. For example, the user may want to carry on a conversation without having the source media content adding to the ambient noise, but desire to feel things like an explosion, a crash, the roar of a crowd, an engine, a ball being hit with a bat or kicked, a tackle, or other similar events that may be expressed with haptic effects (e.g., vibrations or shaking).

In some embodiments, the user 5 may want to watch multiple streams (i.e., separate video components) of live games and selectively toggle between audio streams (i.e., different audio components) to listen as desired.

The computing device 120 may be configured to receive communications from a local venue computing device 150, such as through wireless links 132 that may be relayed via a wireless router 130 that has its own wired or wireless links 135 directly to the local venue computing device 150. The wireless router 130 may provide a wireless local area network (WLAN) capability, such as a Wi-Fi network or Bluetooth communications, such as to receive wireless signals from various wireless devices and provide access to the local venue computing device 150 and/or an external network, such as the Internet.

Alternatively, the computing device 120 may be configured to communicate directly with the remote media player 140 through wireless links 142 or with the local venue computing device 150 via the remote media player 140 functioning with wireless router-like capabilities. As a further alternative, the computing device 120 may be configured to communicate through long-range wireless communications, such as using cellular communications via a cellular network base station 160. In this way, the computing device 120 may also be configured to communicate with a remote server 156 via wireless and/or wired connections 162, 164 to a network 154, which may include a cellular wireless communication network.

The remote media player 140 may receive streams of multimedia content, such as the first multimedia content 145, through wired or wireless links 144 to the local venue computing device 150. In this way, the local venue computing device 150 may control how, what, and when content is rendered by the remote media player 140. In various embodiments, the local venue computing device 150 may be located within or near the venue 10, or located remotely, like the remote server 156 or a cloud-based system, and accessed via the network 154, such as the Internet through communication links 152.

FIG. 1B is a component block diagram of another multi-source multimedia environment 101 suitable for implementing various embodiments. With reference to FIGS. 1A-1B, the illustrated example multi-source multimedia environment 101 may include all the elements, features, and functionality described above with regard to the multi-source multimedia environment (i.e., 100) in FIG. 1A. The multi-source multimedia environment 101 illustrates an example in which the user 5 is using a different computing device 122 in the form of smart glasses. Also, the multi-source multimedia environment 101 includes a slightly different venue 11, which may include a plurality of remote media players 140, 170, 180. In particular, the venue 11 includes the first remote media player 140 rendering the first multimedia content 145, a second remote media player 170 rendering second multimedia content 175, and a third remote media player 180 rendering third multimedia content 185.

In accordance with various embodiments, the user 5 may want one of the audio component, video component, or other perceivable media component from one of the first, second, or third multimedia contents 145, 175, 185 to be played through the computing device 122. For example, although the user 5 may be able to see the display on the second remote media player 170, with the corresponding video component of the second multimedia content 175 thereon, the user 5 may not be able to hear the audio component. In fact, the first, second, and third media players 140, 170, 180 may not be rendering audio to avoid generating too much noise and/or interfering with one another. Thus, desiring to hear the audio component of the second multimedia content 175, in accordance with various embodiments the user 5 may obtain the audio component and have it rendered by the computing device 122. With the audio component rendered by the computing device 122 in synch with the rendering of the video component on the second remote media player 170, the user 5 may have a more enjoyable experience observing and taking in the second multimedia content 175.

By providing a user input on the computing device 122, the user 5 may initiate the process of obtaining the audio component of the second multimedia content 175. For example, by pointing a finger at the second remote media player 170 and particularly in a direction 176 that points towards the second multimedia content 175, the computing device 122 may recognize this gesture (e.g., gesture recognition using camera imaging 124 from the smart glasses) indicating the content that the user 5 wants rendered. The user input may be used to determine the media content that is selected by the user 5 for rendering that content. With the desired content (e.g., the audio component) rendered by the computing device 122 in synch with the rendering of the video component on the second remote media player 170, the user 5 may have a more enjoyable experience observing and taking in the second multimedia content 175.

Alternatively, the user may be able to hear the sound from the audio component of the second multimedia content 175 (e.g., emitted by a nearby speaker), but the user 5 may not be able to see the video component thereof (e.g., due to crowding in the venue 11 or a direction in which the user is seated that does not face the display). Thus, desiring to see the video component of the second multimedia content 175, in accordance with various embodiments the user 5 may obtain the video component and have it rendered by the computing device 122. With the video component rendered by the computing device 122 in synch with the rendering of the audio component from the second remote media player 170, the user 5 may have a more enjoyable experience listening to and observing the second multimedia content 175.

FIG. 1C is a component block diagram of another multi-source multimedia environment 102 suitable for implementing various embodiments. With reference to FIGS. 1A-1C, the illustrated example multi-source multimedia environment 102 may include all the elements, features, and functionality described above with regard to the multi-source multimedia environments (i.e., 100, 101) in FIGS. 1A and 1B. The multi-source multimedia environment 102 illustrates an example in which the user 5 is once again using the computing device 120 in the form of smartphone. Also, the multi-source multimedia environment 102 includes a slightly different venue 12, which may include the first remote media player 140, but now displaying a plurality of multimedia content 145, 175, 185, 195. In particular, the first remote media player 140 is rendering the first multimedia content 145, the second multimedia content 175, and the third multimedia content 185, and a fourth multimedia content 195.

In accordance with various embodiments, the user 5 may want one of the audio component, video component, or other perceivable media component from one of the first, second, third, or fourth multimedia contents 145, 175, 185, 195 to be played through the computing device 120. Thus, desiring to hear the audio component of the fourth multimedia content 195, in accordance with various embodiments the user 5 may obtain the audio component and have it rendered by the computing device 120. With the audio component rendered by the computing device 120 in synch with the rendering of the video component on the first remote media player 140, the user 5 may have a more enjoyable experience observing and taking in the fourth multimedia content 195.

Alternatively, the user may be able to hear the sound from the audio component of the fourth multimedia content 195 (e.g., emitted by a nearby speaker), but the user 5 may not be able to see the video component thereof. Thus, desiring to see the video component of the fourth multimedia content 195, in accordance with various embodiments the user 5 may obtain the video component and have it rendered by the computing device 120. With the video component rendered by the computing device 120 in synch with the rendering of the audio component from the first remote media player 140, the user 5 may have a more enjoyable experience listening to and observing the fourth multimedia content 195.

FIG. 1D is a component block diagram of another multi-source multimedia environment 103 suitable for implementing various embodiments. With reference to FIGS. 1A-1D, the illustrated example multi-source multimedia environment 103 may include all the elements, features, and functionality described above with regard to the multi-source multimedia environments (i.e., 100, 101, 102) in FIGS. 1A-1C. The multi-source multimedia environment 103 illustrates an example in which the user 5 is now using a computing device 121 in the form of a table computing device. Also, the multi-source multimedia environment 103 includes a slightly different venue 13, which may include a fourth remote media player 190 in the form of a speaker. In this way, the fourth remote media player 190 only renders the audio component of a fifth multimedia content 191.

In accordance with various embodiments, the user 5 may want the video component from the fifth multimedia content 191 to be displayed through the computing device 121. Thus, desiring to see the video component of the fifth multimedia content 191, the user 5 may obtain the video component and have it rendered by the computing device 121. With the video component rendered by the computing device 121 in synch with the rendering of the audio component on the fourth remote media player 190, the user 5 may have a more enjoyable experience observing and taking in the fifth multimedia content 191.

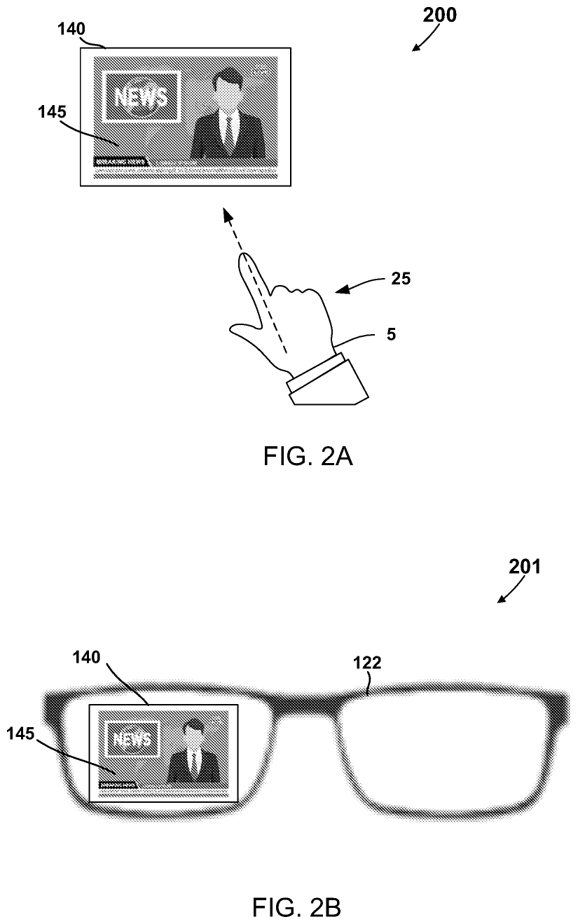

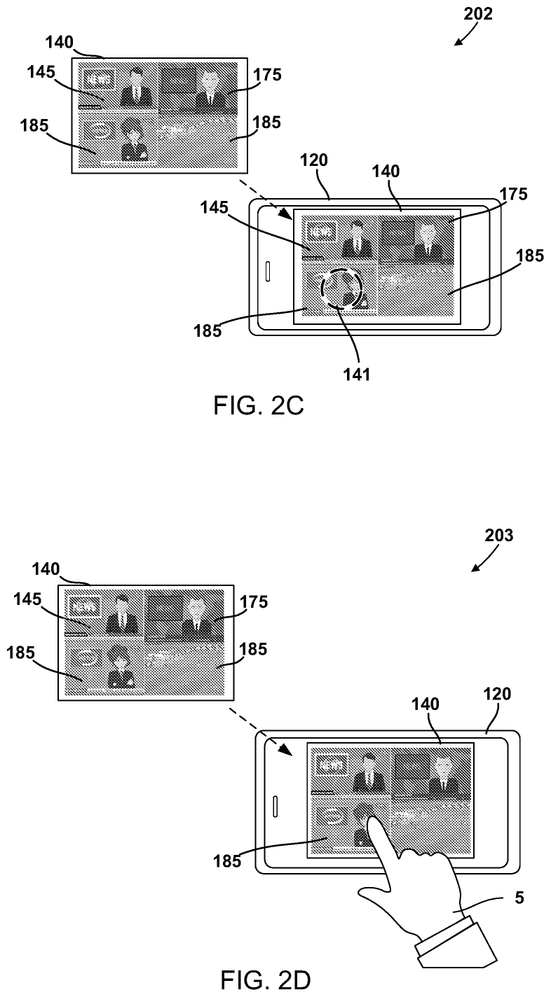

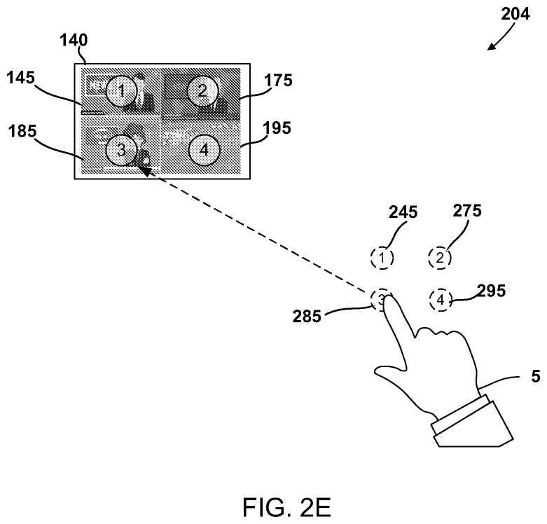

FIGS. 2A-2C are schematic diagrams of exemplary user input techniques suitable for use in various embodiments. With reference to FIGS. 1A-2C, the illustrated user input techniques may enable a user to indicate that the user wants the selected audio component, video component, or other perceivable media component rendered on the computing device.

FIG. 2A is a schematic diagram of a gesture-based user input technique 200 suitable for implementing various embodiments. With reference to FIGS. 1A-2A, the illustrated example gesture-based user input technique 200 may include a gesture detection system that uses a computing device (e.g., 122) that may capture images and recognize gestures made by the user 5. FIG. 2A is illustrated from a point-of-view perspective showing what the imaging system of the computing device may be able to visually capture. Using computer vision and/or other computerized visual recognition systems, the computing device may be able to detect when the user performs a recognized gesture. For example, a gesture detection algorithm run by a processor of the computing device may be configured to detect a pointing gesture 25. The gesture detection algorithm may be configured to detect various different gestures, which may trigger different operations. In this way, when the user 5 configures his or her hand in a particular way (e.g., pointing a finger in a direction) or moves the hand and/or arm in a particular way, such gestures may be recognizable if they meet certain predetermined characteristics.

In addition, the gesture detection algorithm may be configured to analyze and interpret a detected gesture to determine whether characteristics of the gesture may provide additional information associated with a user input. For example, when a pointing gesture is detected, the detected gesture may be analyzed to determine a direction of the pointing and/or identify what the user is pointing at. In this example, interpreting the pointing gesture may determine that the user is pointing at the first multimedia content 145 being rendered on the first media player 140. Alternatively, rather than a pointing gesture (which can be rude or awkward), a user may squint his/her eyes (which is sometimes a natural reaction when trying to see something better), purse her/his lips (e.g., towards the source in which the user is interested), lift his/her head quickly, keep her/his head up, turn her/his head to one side, cup his/her ear, etc. A larger gesture might indicate that the source being identified is further away.

Some embodiments may use ranging sensors to determine how far away objects are in relation to the user/computing device in order to make determinations more easily about what is being pointed at. A distance threshold can be used to rule out objects too far away as being the target of a pointing gesture. In this way, the gesture detection system may rule out objects that are too far in the background by establishing a threshold distance from the computing device. The threshold distance may be equal to or shorter than a distance the user can generally see and/or read a display. Thus, in response to determining that an identified object, and particularly and identified multimedia content is within the threshold distance of the computing device, a processor of the computing device interpret the pointing gesture as a selection of that identified multimedia content. The computing device may provide the user with feedback, such as a visual, haptic, and/or audible output, to let the user know the multimedia content has been identified.

In some embodiments, the user may provide a supplemental gesture as a further user input. Once a particular multimedia content has been identified, an additional gesture by the user may indicate whether the user wants the audio component, video component, or other perceivable media component of the identified multimedia content rendered on the computing device. For example, swiping the pointed finger to the left may indicate the user wants the audio component, whereas swiping the pointing finger to the right may indicate the user wants the video component. A different additional gesture may mean a combination of those things or something entirely different. Thus, interpreting the additional gesture may provide a user input that enables the computing device to identify one of the audio component, video component, or other perceivable media component of the identified multimedia content that the user wants rendered on the computing device.

FIG. 2B is a schematic diagram of a gaze-based user input technique 201 suitable for implementing various embodiments. With reference to FIGS. 1A-2B, the illustrated example gaze-based user input technique 201 may include an eye/gaze direction detection system that uses a computing device 122 that may perform eye tracking to determine at what the user 5 is looking. FIG. 2B is illustrated from a point-of-view perspective showing what the imaging system of the computing device may be able to visually capture. Using computer vision and/or other computerized visual recognition systems in combination with eye tracking, the computing device may be able to detect an object of the user's focus. For example, a gaze detection algorithm run by a processor of the computing device may be configured to detect a focal point and/or a direction of the user's gaze. The gaze detection algorithm may also be configured to detect objects or elements being viewed. Thus, combining a recognized object or element in a direction in which the user is looking may allow the computing device to identify the multimedia content 145 that is being rendered on a display of the media player 140 in the direction of the user's gaze.

FIG. 2C is a schematic diagram of a screen-based user input technique 202 suitable for implementing various embodiments. With reference to FIGS. 1A-2C, the illustrated example screen-based user input technique 202 may use features of a display of the computing device 120 to determine what multimedia content the user (e.g., 5) wants. FIG. 2C is illustrated from a point-of-view perspective showing what the user sees. In particular, the user is looking at the computing device 120 in the foreground and the first media player 140 in the background. More particularly, the user is pointing the camera(s) of the computing device 120 at the first media player 140 so that the first media player 140 and its display are visible on a display of the computing device 120. An application running on the computing device 120 may determine a direction from which the user is perceiving a desired multimedia content based on a direction the camera is facing. In addition, the desired multimedia content may be identified by what appears on the screen of the computing device 120, or more particularly in a target zone 141 on the screen of the computing device 120. By holding the desired multimedia content 185 in the target zone 141 until the application registers the input, the user may provide the user input for selecting the desired multimedia content 185. An additional prompt may be provided for designating which one of either an audio component or a video component associated with multimedia content the user wants rendered on the computing device.

FIG. 2D is a schematic diagram of another screen-based user input technique 203 suitable for implementing various embodiments. With reference to FIGS. 1A-2D, the illustrated example screen-based user input technique 203 may use features of a touch-screen display of the computing device 120 to determine what multimedia content the user (e.g., 5) wants. FIG. 2D is illustrated from a point-of-view perspective that shows what the user sees. In particular, the user is looking at the computing device 120 in the foreground and the first media player 140 in the background. More particularly, the user is pointing the camera(s) of the computing device 120 at the first media player 140 so the that the first media player 140 and its display are visible on a display of the computing device 120. An application running on the computing device 120 may determine a direction from which the user is perceiving a desired multimedia content based on a direction the camera is facing. In addition, the desired multimedia content may be identified by an additional user input, such as a screen tap on a portion of the screen of the computing device 120 that corresponds to the desired multimedia content 185. An additional prompt may be provided for designating which one of either an audio component or a video component associated with multimedia content the user wants rendered on the computing device 120.

FIG. 2E is a schematic diagram of another XR overlay-based user input technique 204 suitable for implementing various embodiments. With reference to FIGS. 1A-2E, the illustrated example XR overlay-based user input technique 204 may use features of a field-of-view overlays that may be rendered by the computing device (e.g., 122) in the form of smart glasses to determine what multimedia content the user 5 wants. FIG. 2E is illustrated from a point-of-view perspective showing what the user sees. In particular, the user 5 is looking through the computing device 122, seeing the first media player 140 in the background. In accordance with various embodiments, the computing device 120 may project overlays 1, 2, 3, 4 onto the user's field of view in order to add labels to each of the first, second, third, and fourth multimedia contents 145, 175, 185, 195. The projected overlays 1, 2, 3, 4 may appear to the user 5 to rest on top of the first, second, third, and fourth multimedia contents 145, 175, 185, 195. In order to select one of the projected overlays 1, 2, 3, 4, the user 5 may touch a region in the air 245, 275, 285, 295 that appears to the user to correspond to the user covering a corresponding overlay 1, 2, 3, 4 on the first media player 140.

An application running on the computing device (e.g., 122) may determine which of the overlays 1, 2, 3, 4 that was selected by the user 5. In this way, the desired multimedia content may be identified by the user performing a virtual interaction with the screen of the first multimedia device 140. An additional user input, such as a swipe gesture in a particular direction may designate which one of either an audio component or a video component associated with multimedia content the user wants rendered on the computing device 122.

Various embodiments may use alternative or additional user input techniques. For example, the computing device may be configured to receive verbal input from the user 5 (e.g., using speech recognition). As another example, the computing device may project a hologram or marker over selection in the user's visual field, which may be used to enter and/or confirm the user input. Similarly, the computing device may present a list from which the user may select to provide user input. The list was obtained by the computing device from local computing device and/or a remote computing device. Information for populating such a list may obtained by the computing device, actively, passively, or after a trigger event such as in response to a user request to do so.

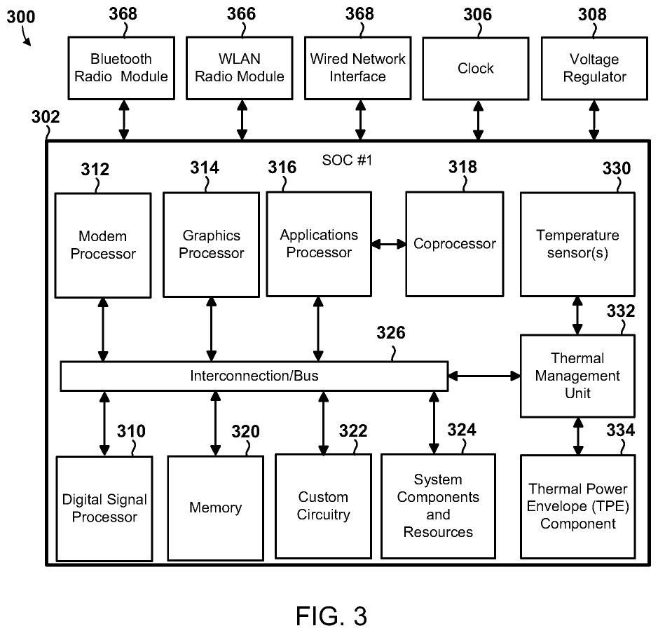

FIG. 3 is a component block diagram illustrating a non-limiting example of a computing and wireless modem system 300 in a computing device suitable for implementing any of the various embodiments, including in a computing device.

Various embodiments may be implemented on a number of single processor and multiprocessor computer systems, including a system-on-chip (SOC) or system in a package (SIP).

With reference to FIGS. 1-3, the illustrated example computing system 300 (which may be a SIP in some embodiments) includes an SOC 302 coupled to a clock 306, a voltage regulator 308, a radio module 366 configured to send and receive wireless communications, including Bluetooth (BT) and Bluetooth Low Energy (BLE) messages, via an antenna (not shown and an inertial measurement unit) (IMU) 368. When the computing system 300 is used in computing devices, the radio module 366 may be configured to broadcast BLE and/or Wi-Fi beacons. In some implementations, the SOC 302 may operate as central processing unit (CPU) of the user mobile device that carries out the instructions of software application programs by performing the arithmetic, logical, control and input/output (I/O) operations specified by the instructions.

The SOC 302 may include a digital signal processor (DSP) 310, a modem processor 312, a graphics processor 314, an application processor 316, one or more coprocessors 318 (such as vector co-processor) connected to one or more of the processors, memory 320, custom circuitry 322, system components and resources 324, an interconnection/bus module 326, one or more temperature sensors 330, a thermal management unit 332, and a thermal power envelope (TPE) component 334. A second SOC (not shown) may include other elements like a 5G modem processor, a power management unit, an interconnection/bus module, a plurality of mm Wave transceivers, additional memory, and various additional processors, such as an applications processor, packet processor, etc.

Each processor 310, 312, 314, 316, 318 may include one or more cores, and each processor/core may perform operations independent of the other processors/cores. For example, the SOC 302 may include a processor that executes a first type of operating system (such as FreeBSD, LINUX, OS X, etc.) and a processor that executes a second type of operating system (such as MICROSOFT WINDOWS 10). In addition, any or all of the processors 310, 312, 314, 316, 318 may be included as part of a processor cluster architecture (such as a synchronous processor cluster architecture, an asynchronous or heterogeneous processor cluster architecture, etc.).

The SOC 302 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 324 of the SOC 302 may include power amplifiers, voltage regulators, oscillators, phase-locked loops, peripheral bridges, data controllers, memory controllers, system controllers, access ports, timers, and other similar components used to support the processors and software clients running on a user mobile device. The system components and resources 324 or custom circuitry 322 also may include circuitry to interface with peripheral devices, such as cameras, electronic displays, wireless communication devices, external memory chips, etc.

The SOC 302 may communicate via interconnection/bus module 326. The various processors 310, 312, 314, 316, 318, may be interconnected to one or more memory elements 320, system components and resources 324, and custom circuitry 322, and a thermal management unit 332 via an interconnection/bus module 326. The interconnection/bus module 326 may include an array of reconfigurable logic gates or implement a bus architecture (such as CoreConnect, AMBA, etc.). Communications may be provided by advanced interconnects, such as high-performance networks-on chip (NoCs).

The SOC 302 may further include an input/output module (not illustrated) for communicating with resources external to the SOC, such as a clock 306 and a voltage regulator 308. Resources external to the SOC (such as clock 306, voltage regulator 308) may be shared by two or more of the internal SOC processors/cores.

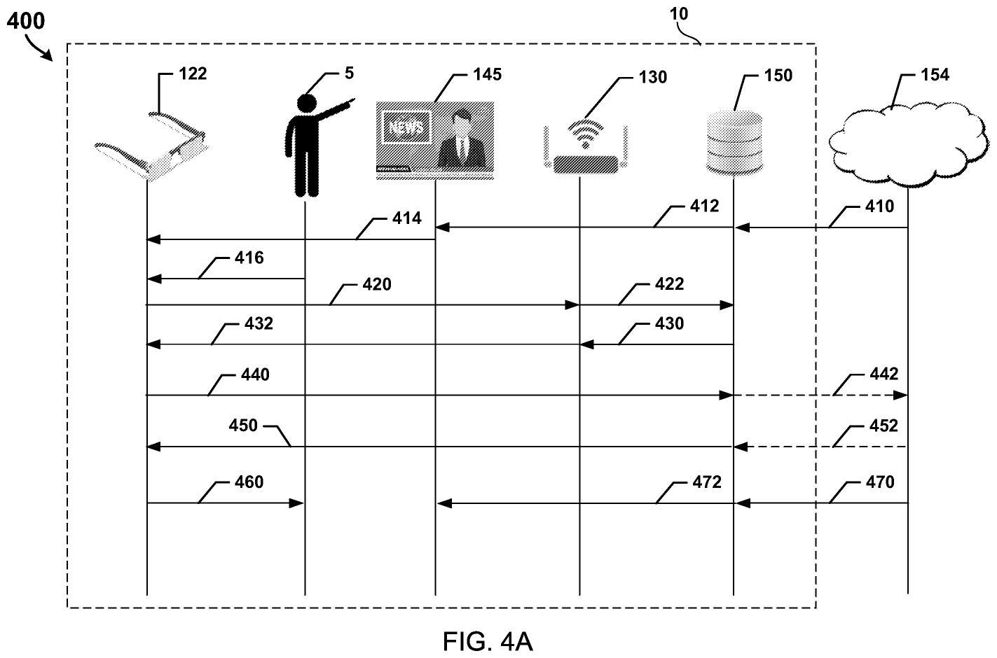

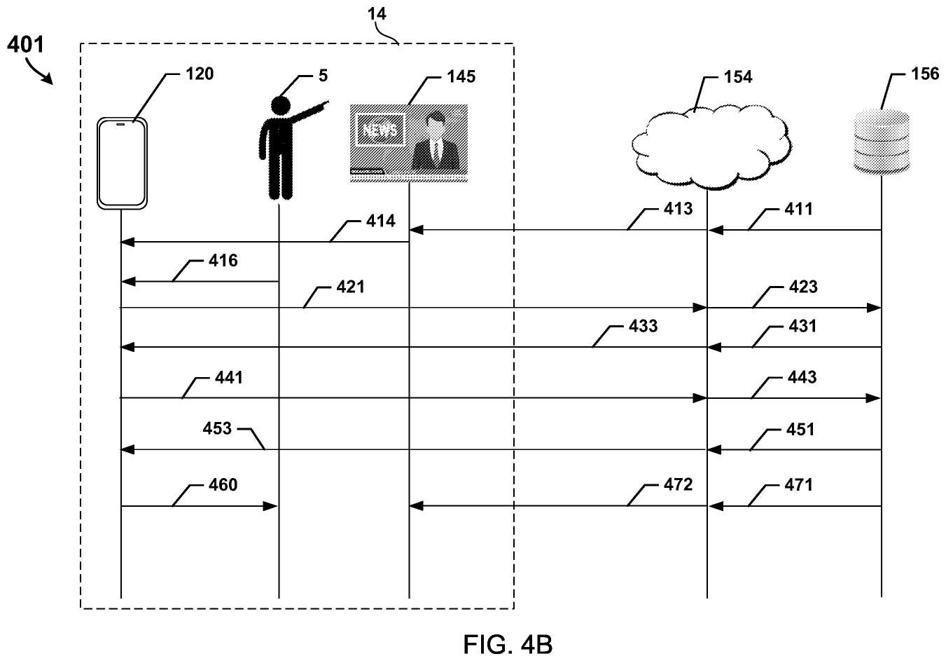

FIG. 4A is a communication flow diagram illustrating an example method 400 for multi-source multimedia output and synchronization in a computing device. With reference to FIGS. 1-4A, the method 400 shows an example of a multi-source multimedia output and synchronization scenario that involves a gaze-based user input combined with metadata retrieval in accordance with various embodiments.

The method 400 may be initiated in response to a media player (e.g., remote media player 140) rendering multimedia content, such as the first multimedia content 145. A content provider located off-premises may deliver multimedia content via the Internet or other communication network 154 to the venue 11. For example, a cable television provider or internet service provider may supply a stream 410 of multimedia content to a local computing device 150, such as a cable box or router, which may in-turn convey the received stream 412 to the media player that is remote (i.e., separated from) the user 5. The received stream 412 may be rendered on the media player as the first multimedia content 145.

In various embodiments, the user 5 who is wearing the computing device 122 and looking toward the first multimedia content 145 may initiate the multi-source multimedia output and synchronization with a user input to the computing device 122 designed to initiate the process. For example, using a gesture-based command, the user 5 may initiate the process by performed a predetermined gesture, such as a pointing gesture.

In response to the user 5 looking toward the first multimedia content 145, a camera or other sensor of the computing device 122 may capture images 414 from the media player that include the first multimedia content 145. A processor of the computing device 122 may scan the captured images 414 and register that the first multimedia content 145 was detected. In addition, in response to the user 5 pointing at something (i.e., performing a gesture), a camera or other sensor of the computing device 122 may capture additional images 416 of the user performing the gesture. A processor of the computing device 122 may scan the additional captured images 416 and register that the user has performed a multimedia selection gesture. The combination of performing the predetermined gesture (e.g., the pointing gesture) in the direction of registered multimedia content 145 may initiate the process of multi-source multimedia output and synchronization. The user's gesture may be considered a received user input selecting one of either an audio component or a video component associated with multimedia content being rendered by a remote media player within in a perceptible distance of a user of the computing device 122.

In response to receiving the user input in the form of the additional images 416 that contained the initiating gesture, a processor of the computing device 122 may attempt to identify the multimedia content 145 selected by the user. In order to do so, the processor of the computing device 122 may transmit a query to a computing device. For example, the processor may use a radio module to transmit a local query 420 to a local computing device 150, such as a venue computer housing a database.

The local query 420 may be received by the router 130 in the venue 10. The router 130 may be configured to provide access to the local computing device 150 by passing along the local query as a secure communication 422 to the local computing device 150.

In response to receiving the secure communication 422, the local computing device 150 may perform a database lookup to identify the selected multimedia content. For example, the local computing device 150 may identify the first media content 145 as the selected multimedia content. The local computing device 150 may thus transmit an intermediate response 430 to the router 130, which the router 130 may transmit as a query response 432 to the computing device 122. The query response 432 may contain metadata that specifically identifies the first multimedia content 145. Alternatively, the query response 432 may include a link for obtaining identification information from a remote database (e.g., 156).

Using the obtained metadata, the computing device 122 may transmit a request to obtain the multimedia content from a source of the multimedia content. For example, the metadata may not only identify the first multimedia content 145 but may also indicate that the local computing device 150 may supply the audio component, video component, or other perceivable media component from the identified source of the multimedia content. In this way, the computing device may transmit a local request 440 to the local computing device 150 (via the router 130) for the multimedia content.

Alternatively, the metadata may not indicate how to obtain the multimedia content or may indicate it must be obtained from a remote server (e.g., 156), such as from a content service provider. In which case, the computing device may transmit a remote request 442 to a remote computing device via the communication network 154 for the multimedia content.

The multimedia content displayed at some commercial venues (e.g., 10) may be restricted by a paywall, which may inhibit a computing device's ability to look-up or obtain the desired multimedia content on display at that venue. Thus, in accordance with various embodiments, the commercial venue may extend their subscription (i.e., license), at least temporarily to a computing device with access to the venue's local network, so that users at the commercial venue may pass the paywall and obtain more detailed information about the multimedia stream (e.g., accessed through Wi-Fi or BTE) and/or even obtain the multimedia content itself using the extended subscription. Some venues may offer this as an automatic guest pass or optionally provided this extended subscription service at a cost or a way to offer subscriptions. Thus, the query response 432 from the router 130 may include subscription access to the multimedia content from the source of the media content. In this way, the computing device 122 may later receive the identified audio component, video component, or other perceivable media component of the multimedia content based on the subscription access.

If available, the local computing device 150 may respond to the request 440 by establishing a connection 450 with the computing device 122 (e.g., via the router 130) configured to provide the computing device with a data stream for delivering the requested first multimedia content 145. Although the user 5 may have only selected one of the audio or video components to be rendered by the computing device 122, both the audio and video components, as well as any XR enhancements of the requested first multimedia content 145 may be obtained by the computing device 122 (i.e., received from the local computing device 150).

The additional content components not selected by the user 5 for rendering on the computing device 122 may be used by the computing device 122 to effectively render the selected one of the audio component, video component, or other perceivable media component from the obtained multimedia content. For example, although the computing device 122 may only need to render the audio component of the multimedia content, the obtained video component may be used by the computing device 122 to properly synchronize delivery of the audio component. Similarly, the computing device 122 may use any XR enhancements, such as overlays, as part of the rendering of the selected multimedia content. Thus, since the media player (e.g., 140) may continue receiving the first multimedia content 145, both the media player and the computing device 122 may receive both the audio component and the video component as part of the obtained multimedia content.

Alternatively, if the computing device had to obtain the multimedia content from the remote server (e.g., 156) that received the request 442, the remote server may respond by establishing a connection 452 configured to provide the computing device 122 with a data stream for delivering the requested first multimedia content 145. The delivery of the requested first multimedia content 450 to the computing device 122 from the remote server may be similar to the deliver from the local computing device 150, although access through the router 130 may not be necessary (e.g., when using cellular communication services). As noted above, both the media player and the computing device 122 may receive both the audio component and the video component as part of the obtained multimedia content.

Once the computing device 122 starts receiving the first multimedia content 145, the computing device 122 may start rendering 460 the selected one of the audio component, video component, or other perceivable media component from the obtained multimedia content. When rendering the obtained multimedia content, the computing device 122 may synchronize that rendering with the rendering by the media player of the stream 470, 472 from the source.

To synchronize the rendering of the selected one of the audio component, video component, or other perceivable media component from the obtained multimedia content, the computing device 122 may ensure the deliver timing of the selected component matches the delivery timing of the other component rendered by the remote media player. To synchronize, the computing device 122 may need to speed up or slow down the output of the requested audio or video component in order to match the timing of the multimedia stream from the remote media player.

Processing delays associated with video rendering may be used to synchronize audio rendered by the computing device 122. In normal video rendering, the audio component and the video component may arrive together, but the video component may be delayed as part of the rendering process. In various embodiments, the computing device 122 may leverage the delay in the rendering of the video component to buffer the audio component and use the buffered audio to synchronize based on additional video image sampling done as part of the synchronization process. In other words, since the processing time for the video stream is significantly longer than that of the audio stream, the received audio stream may be buffered in order to synchronize the audio output with the video output from the remote media player.

As part of the video sampling for the synchronization process, the computing device 122 may capture an image observable on the media player and associated with a particular point in the related audio stream at time X. From that point, as long as a collective processing delay T of the media player and/or the computing device 122 are known, that collective processing delay may be used to determine the timing (X+T) of the output of the synchronized audio stream. That processing delay T may be 10-100 milliseconds, but that may be enough time to calculate and output a received audio stream in synchronization with the multimedia streaming on the media player. Even live multimedia is not technically live; it is delay by 10-100 milliseconds, which delay may be used to time the synchronization. Various embodiments may employ other known synchronization techniques.

The synchronization system receives data regarding the multimedia stream (either shared with the streaming device locally or obtained from a remote source), which includes both the audio and the video components. Thereafter, by matching the observed video on the media player with the video in the multimedia stream, the audio from the multimedia stream may be synchronized.

The synchronization of sound and imaging may be continuous through continued observation of the multimedia content stream to synchronize sound, such as through reading lips. This may achieve a fine-grain synchronization or refine an existing synchronization. For non-live broadcasts, audio events within the multimedia content may be known and used to synchronize the playback (e.g., knowing when a particular sound is expected to occur during the multimedia playback). For example, a video sequence that includes a clap or another stink sharp sound that is associated with a visual event may be used for synchronization.

Interruptions (e.g., commercials) or changes in the multimedia broadcast may cause a new multimedia streaming detection event that restarts the process from the beginning. However, since commercials are not generally live streams, the content thereof may be readily available ahead of time.

FIG. 4B is a communication flow diagram illustrating an example method 401 for multi-source multimedia output and synchronization in a computing device. With reference to FIGS. 1-4B, the method 401 shows an example of a multi-source multimedia output and synchronization scenario that involves a gesture-based user input combined with a remote network lookup to identify and obtain the multimedia content in accordance with various embodiments. The example method 401 may provide the multi-source multimedia output and synchronization without support from a local venue or network. Without the need for support from the local venue, users of computing devices may use the multi-source multimedia output and synchronization techniques of various embodiments in almost any venue.

The method 401 may be initiated in response to a media player (e.g., remote media player 140) rendering multimedia content, such as the first multimedia content 145. A content provider located off-premises, which may have a remote server 156, may deliver multimedia content via the Internet or other communication network 154 to the venue 14. For example, a content provider may supply a stream 411 of multimedia content to the media player (e.g., 140), via a communication network 154, which may in-turn convey the received stream 413 to the media player that is remote (i.e., separated from) the user 5. The received stream 413 may be rendered on the media player as the first multimedia content 145.

As described above with regard to the method 400, the user 500 may initiate the multi-source multimedia output and synchronization. In response to receiving the user input that initiated the process, a processor of the computing device 120 may attempt to identify the multimedia content 145 selected by the user. In order to do so, since there is no local database to query, the processor of the computing device 122 may transmit a query to a remote computing device. For example, the processor may use a radio module to transmit a remote query 421 to a remote computing device 156, such as a multimedia database.

The remote query 421 may be received by the communication network 154 and passing along as a network query 423 to the remote computing device 156.

The remote query 421 may request identification of a selected multimedia content for identification thereof. Alternatively, if the identity of the multimedia content is somehow already known, the remote query 421 may request information regarding a source of the multimedia content. The remote query 421 may include a sampling of the multimedia content, such as a short video or a screen shot of the first multimedia content. Such sampling may be referred to as “fingerprinting,” since the collected image(s) are used to identify the content.

Multimedia content fingerprinting may take a small sampling of the multimedia stream for matching to a database of multimedia to identify what particular multimedia content was captured, and what point therein, is being observed. The lookup database may be local to the venue presenting the multimedia in question or a remote database or collection of databases. A remote database or collection of databases may form a repository for information regarding all or most multimedia, providing a multimedia lookup. Even if not all multimedia content is available for lookup, if a sufficient amount of multimedia content is available for lookup, such a service may be useful to users. The fingerprinting may be continuous, at regular intervals, at intervals initiated by the media player (pushed) or the computing device (e.g., pulled from user input or process on the computing device).

The lookup of multimedia content may also use additional sensor information. For example, sensor data from the computing device 120 (e.g., location, date/time, orientation) may be used to assist in the identification of the multimedia content. A remote server may determine the venue based on such sensor data, which may narrow down or identify precisely what multimedia content is being streamed there. Such location, orientation, and temporal information may identify an establishment, a location/orientation in an establishment (e.g., near one or more multimedia displays) to aid in identifying the selection.

The remote query 421 may be received by the communication network 154 and passing along as a network query 423 to the remote computing device 156. If available, the remote server 156 may respond to the by establishing a connection with the computing device 120 via a series of communications 431, 433, 441, 443 between the remote server 421, network 154 and mobile device 120, with the connection configured to provide the computing device 120 with a data stream for delivering the requested first multimedia content 145. In some implementations, the remote server 156 may send request 431, 433 for a code or license information of the mobile device 120 indicating the user has paid for or otherwise received a license or pass to receive the multimedia content, and the mobile device 120 may reply in messages 441, 443 with re requested code or license information. Once the connection is established, the remote server 154 may begin delivery of the requested first multimedia content to the computing device 120 via streaming communications 451, 453 similar to the deliver from the local computing device (e.g., 150), although access through a local router (e.g., 130) may not be necessary (e.g., when using cellular communication services). As noted above, both the media player and the computing device 120 may receive both the audio component and the video component as part of the obtained multimedia content.

Once the computing device 120 starts receiving the first multimedia content 145, the computing device 120 may begin rendering 460 the selected one of the audio component, video component, or other perceivable media component from the obtained multimedia content. When rendering the obtained multimedia content, the computing device 120 may synchronize that rendering with the rendering by the media player of the stream 471, 472 from the source.

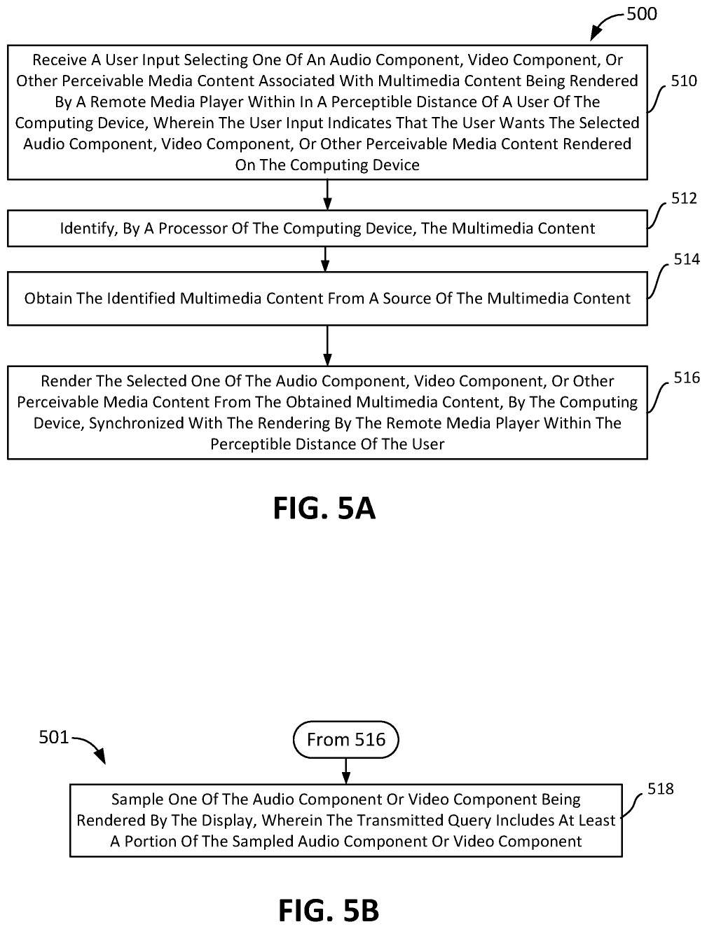

FIG. 5A is a process flow diagram illustrating a method 500 for multi-source multimedia output and synchronization in a computing device, in accordance with various embodiments. With reference to FIGS. 1-5, means for performing each of the operations of the method 500 may be performed by a processor (e.g., 302, 310, 312, 314, 316, and/or 318) and/or a transceiver (e.g., 366) of a computing device (e.g., 120, 122) and the like. Alternatively, means for performing each of the operations of the method 500 may be a processor of the computing device, computing device associated with the local venue, or other computing device working in combination (e.g., a remote computing device, such as a remote server 156).

In block 510, the computing device may receive a user input selecting one of either an audio component or a video component associated with user-identified multimedia content being rendered by a remote media player within in a perceptible distance of the user of the computing device. The user input may indicate that the user wants the selected audio component, video component, or other perceivable media component to be rendered on the computing device.

In some embodiments, the multimedia content may be selected by the user from a plurality of multimedia content observable by the user, with the selection communicated to the computing device via various methods.

In some embodiments, receiving the user input by the computing device may include detecting a gesture performed by the user. The detected gesture may be interpreted by the computing device to determine whether it identifies a multimedia content being rendered within a threshold distance of the computing device. By interpreting the detected gesture, the computing device may identify one of the audio component, video component, or other perceivable media component of the identified multimedia content that the user wants rendered on the computing device.

In some embodiments, receiving the user input by the computing device may include receiving a camera image of the multimedia when the user points the camera of the computing device or a connected mobile device at a remote media player. The computing device may use the received camera to identify the multimedia content being rendered within visual range of the computing device.

In block 512, a processor of the computing device may identify the multimedia content. In some embodiments, identifying the multimedia content that is being rendered on a display within in a perceptible distance of a user of the computing device may include detecting a gaze direction of the user. Also, the multimedia content may be identified that is being rendered on the display in the direction of the user's gaze. In some embodiments, identifying the multimedia content that is being rendered on a display within in a perceptible distance of a user of the computing device may include receiving a user input indicating a direction from which the user is perceiving the multimedia content. In addition, the multimedia content may be identified based on the received user input.

In block 514, the processor of the computing device may obtain the identified multimedia content from a source of the multimedia content. Receipt by the computing device of the multimedia content may mean each of the remote media player and the computing device receive both the audio component and the video component as part of the obtained multimedia content.

In some embodiments, obtaining the identified audio component, video component, or other perceivable media component of the multimedia content from a source of the multimedia content may include obtaining metadata regarding the multimedia content. Also, the obtained metadata may be used to identify a source of the multimedia content. In addition, the audio component, video component, or other perceivable media component may be obtained from the identified source of the multimedia content.

In some embodiments, obtaining the identified audio component, video component, or other perceivable media component of the multimedia content from a source of the multimedia content may include transmitting a query to a remote computing device regarding the multimedia content. Also, identification may be requested of a source of the multimedia content. In addition, the audio component, video component, or other perceivable media component may be obtained from the identified source of the multimedia content.

In some embodiments, obtaining the identified audio component, video component, or other perceivable media component of the multimedia content from a source of the multimedia content may include obtaining subscription access to the multimedia content from the source of the media content. Also, the identified audio component, video component, or other perceivable media component of the multimedia content may be received based on the subscription access.

In block 516, the processor of the computing device may render the selected one of the audio component, video component, or other perceivable media component from the obtained multimedia content. This rendering by the computing device may be synchronized with the rendering by the remote media player within the perceptible distance of the user.

In some embodiments, rendering the selected one of the audio component, video component, or other perceivable media component, by the computing device, synchronized with the rendering by the remote media player within in the perceptible distance of the user may include sampling one or more of the audio component, video component, or other perceivable media component of the multimedia content being rendered by the remote media player within the perceptible distance of the user. Also, a timing difference may be determined between the samples of one or more of the audio component, video component, or other perceivable media component of the multimedia content being rendered and the audio component, video component, or other perceivable media component obtained from the source of the multimedia content. Further the selected one of the audio component, video component, or other perceivable media component may be rendered by the computing device so that the user will perceive the selected one of the audio component, video component, or other perceivable media component so rendered to be synchronized with the perceptible multimedia content rendered by the remote media player.

FIG. 5B illustrates additional operations 501 that the processor of the computing Device may perform in addition to the method 500 to output and synchronize multi-source multimedia content in a computing device. In block 518, the processor may sample one of the audio component or video component being rendered by the display, wherein the transmitted query includes at least a portion of the sampled audio component or video component.

In some embodiments, at least one of the identification of the multimedia content or the synchronization with the rendering by the remote media player may be based on information received in response to the transmitted query.

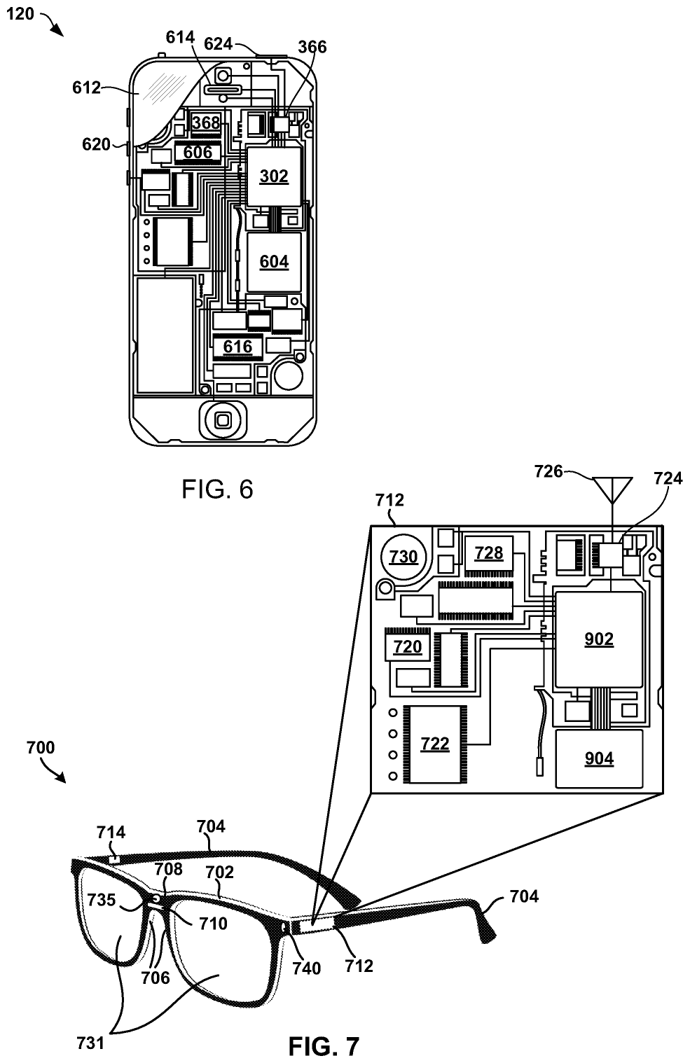

FIG. 6 is a component block diagram of a user mobile device 120 suitable for use as a user mobile device or a consumer user equipment (UE) when configured with processor executable instructions to perform operations of various embodiments. With reference to FIGS. 1-6, the user mobile device 120 may include a SOC 302 (e.g., a SOC-CPU) coupled to a second SOC 604 (e.g., a 5G capable SOC). The first and second SOCs 302, 604 may be coupled to internal memory 606, 616, a display 612, and to a speaker 614. Additionally, the user mobile device 120 may include an antenna 624 for sending and receiving electromagnetic radiation that may be connected to a radio module 366 configured to support wireless local area network data links (e.g., BLE, Wi-Fi, etc.) and/or wireless wide area networks (e.g., cellular telephone networks) coupled to one or more processors in the first and/or second SOCs 302, 604. The user mobile device 120 typically also include menu selection buttons 620 for receiving user inputs.

A typical user mobile device 120 may also include an inertial measurement unit (IMU) 368 that includes a number of micro-electromechanical sensor (MEMS) elements configured to sense accelerations and rotations associated movements of the device, and provide such movement information to the SOC 302. Also, one or more of the processors in the first and second SOCs 302, 604, radio module 366 may include a digital signal processor (DSP) circuit (not shown separately).

Various embodiments (including embodiments discussed above with reference to FIGS. 1A-11I) may be implemented on a variety of wearable devices, an example of which is illustrated in FIG. 7 in the form of smart glasses 700. With reference to FIGS. 1A-7, the smart glasses 700 may operate like conventional eye glasses, but with enhanced computer features and sensors, like a built-in camera 735 and heads-up display or AR features on or near the lenses 731. Like any glasses, smart glasses may include a frame 702 coupled to temples 704 that fit alongside the head and behind the ears of a wearer. The frame 702 holds the lenses 731 in place before the wearer's eyes when nose pads 706 on the bridge 708 rest on the wearer's nose.

In some embodiments, smart-glasses 700 may include an image rendering device 714 (e.g., an image projector), which may be embedded in one or both temples 704 of the frame 702 and configured to project images onto the optical lenses 731. In some embodiments, the image rendering device 714 may include a light-emitting diode (LED) module, a light tunnel, a homogenizing lens, an optical display, a fold mirror, or other components well known projectors or head-mounted displays. In some embodiments (e.g., those in which the image rendering device 714 is not included or used), the optical lenses 731 may be, or may include, see-through or partially see-through electronic displays. In some embodiments, the optical lenses 731 include image-producing elements, such as see-through Organic Light-Emitting Diode (OLED) display elements or liquid crystal on silicon (LCOS) display elements. In some embodiments, the optical lenses 731 may include independent left-eye and right-eye display elements. In some embodiments, the optical lenses 731 may include or operate as a light guide for delivering light from the display elements to the eyes of a wearer.

The smart-glasses 710 may include a number of external sensors that may be configured to obtain information about wearer actions and external conditions that may be useful for sensing images, sounds, muscle motions and other phenomenon that may be useful for detecting when the wearer is interacting with a virtual user interface as described. In some embodiments, smart-glasses 700 may include a camera 735 configured to image objects in front of the wearer in still images or a video stream, which may be transmitted to another computing device (e.g., a mobile device 120) for analysis. Additionally, the smart-glasses 700 may include a lidar sensor 740 or other ranging device. In some embodiments, the smart-glasses 700 may include a microphone 710 positioned and configured to record sounds in the vicinity of the wearer. In some embodiments, multiple microphones may be positioned in different locations on the frame 702, such as on a distal end of the temples 704 near the jaw, to record sounds made when a user taps a selecting object on a hand, and the like. In some embodiments, smart-glasses 700 may include pressure sensors, such on the nose pads 706, configured to sense facial movements for calibrating distance measurements. In some embodiments, smart glasses 700 may include other sensors (e.g., a thermometer, heart rate monitor, body temperature sensor, pulse oximeter, etc.) for collecting information pertaining to environment and/or user conditions that may be useful for recognizing an interaction by a user with a virtual user interface

The processing system 712 may include processing and communication SOCs 902, 904 which may include one or more processors 902, 904, one or more of which may be configured with processor-executable instructions to perform operations of various embodiments. The processing and communications SOC 902, 904 may be coupled to internal sensors 720, internal memory 722, and communication circuitry 724 coupled one or more antenna 726 for establishing a wireless data link with an external computing device (e.g., a mobile device 120), such as via a Bluetooth link. The processing and communication SOCs 902, 904 may also be coupled to sensor interface circuitry 728 configured to control and received data from a camera 735, microphone(s) 710, and other sensors positioned on the frame 702.

The internal sensors 720 may include an IMU that includes electronic gyroscopes, accelerometers, and a magnetic compass configured to measure movements and orientation of the wearer's head. The internal sensors 720 may further include a magnetometer, an altimeter, an odometer, and an atmospheric pressure sensor, as well as other sensors useful for determining the orientation and motions of the smart glasses 700. Such sensors may be useful in various embodiments for detecting head motions that may be used to adjust distance measurements as described.

The processing system 712 may further include a power source such as a rechargeable battery 730 coupled to the SOCs 902, 904 as well as the external sensors on the frame 702.

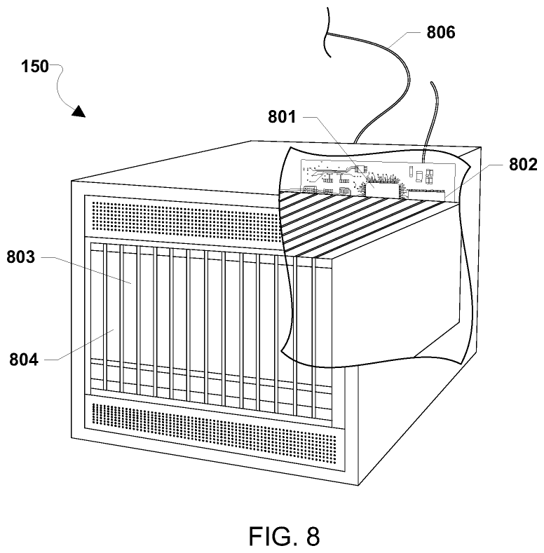

FIG. 8 is a component block diagram of a local venue computing device 150 suitable for use with various embodiments. With reference to FIGS. 1-8, the local venue computing device 150 may typically include a processor 801 coupled to volatile memory 802 and a large capacity nonvolatile memory, such as a disk drive 803. The local venue computing device 150 may also include a peripheral memory access device, such as a floppy disc drive, compact disc (CD) or digital video disc (DVD) drive 806 coupled to the processor 801. The local venue computing device 150 may also include network access ports 804 (or interfaces) coupled to the processor 801 for establishing data connections with a network, such as the Internet and/or a local area network coupled to other system computers and servers. The local venue computing device 150 may be coupled to one or more antennas (not shown) for sending and receiving electromagnetic radiation that may be connected to a wireless communication link. The local venue computing device 150 may include additional access ports, such as USB, Firewire, Thunderbolt, and the like for coupling to peripherals, external memory, or other devices.

The processors of the user mobile device 120, and the local venue computing device (e.g., 150) may be any programmable microprocessor, microcomputer or multiple processor chip or chips that can be configured by software instructions (applications) to perform a variety of functions, including the functions of the various embodiments described below. In some user mobile devices, multiple processors may be provided, such as one processor within an SOC (e.g., 604) dedicated to wireless communication functions and one processor within an SOC (e.g., 302) dedicated to running other applications. Typically, software applications may be stored in the memory 606 before they are accessed and loaded into the processor. The processors may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 400, 401, 500, 501 may be substituted for or combined with one or more operations of the method 400, 401, 500, 501.

Implementation examples are described in the following paragraphs. While some of the following implementation examples are described in terms of example methods, further example implementations may include: the example methods discussed in the following paragraphs implemented by a local venue computing device (or other entity), and/or a user mobile device, including a processor configured to perform operations of the example methods; the example methods discussed in the following paragraphs implemented by a local venue computing device (or other entity), and/or a user mobile device, including means for performing functions of the example methods; the example methods discussed in the following paragraphs implemented in a processor used in a local venue computing device (or other entity), and/or a user mobile device that is configured to perform the operations of the example methods; and the example methods discussed in the following paragraphs implemented as a non-transitory processor-readable storage medium having stored thereon processor-executable instructions configured to cause a processor or modem processor to perform the operations of the example methods.

Example 1. A method for multi-source multimedia output and synchronization in a computing device, including receiving a user input selecting one of either an audio component or a video component associated with multimedia content being rendered by a remote media player within in a perceptible distance of a user of the computing device, in which the user input indicates that the user wants the selected audio component, video component, or other perceivable media component rendered on the computing device; identifying, by a processor of the computing device, the multimedia content; obtaining the identified multimedia content from a source of the multimedia content; and rendering the selected one of the audio component, video component, or other perceivable media component from the obtained multimedia content, by the computing device, synchronized with the rendering by the remote media player within the perceptible distance of the user.

Example 2. The method of example 1, in which the multimedia content is selected by the user from a plurality of multimedia content observable by the user.

Example 3. The method of either one of examples 1 or 2, in which receiving a user input includes: detecting a gesture performed by the user; interpreting the detected gesture to determine whether it identifies the multimedia content being rendered within a threshold distance of the computing device; and identifying one of the audio component, video component, or other perceivable media component of the identified multimedia content that the user wants rendered on the computing device.

Example 4. The method of any one of examples 1-3, in which identifying the multimedia content that is being rendered on a display within a perceptible distance of the user of the computing device includes detecting a gaze direction of the user; and identifying the multimedia content that is being rendered on the display in the direction of the user's gaze.

Example 5. The method of example 4, in which identifying multimedia content that is being rendered on the display within a perceptible distance of a user of the computing device includes receiving a user input indicating a direction from which the user is perceiving the multimedia content; and identifying the multimedia content based on the received user input.

Example 6. The method of any one of examples 1-5, in which obtaining the identified audio component, video component, or other perceivable media component of the multimedia content from a source of the multimedia content includes obtaining metadata regarding the multimedia content; using the obtained metadata to identify a source of the multimedia content; and obtaining the audio component, video component, or other perceivable media component from the identified source of the multimedia content.

Example 7. The method of any one of examples 1-6, in which obtaining the identified audio component, video component, or other perceivable media component of the multimedia content from a source of the multimedia content includes transmitting a query to a remote computing device regarding the multimedia content; requesting identification of a source of the multimedia content; and obtaining the audio component, video component, or other perceivable media component from the identified source of the multimedia content.

Example 8. The method of example 7, further including sampling one of the audio component or video component being rendered by the remote media player, wherein the transmitted query includes at least a portion of the sampled one of the audio component or video component.

Example 9. The method of example 7, in which at least one of the identification of the source of the multimedia content or the synchronization with the rendering by the remote media player is based on information received in response to the transmitted query.

Example 10. The method of any one of examples 1-9, in which obtaining the identified multimedia content from a source of the multimedia content includes obtaining subscription access to the multimedia content from the source of the multimedia content; and receiving the identified audio component, video component, or other perceivable media component of the multimedia content based on the obtained subscription access.

Example 11. The method of any one of examples 1-10, in which rendering the selected one of the audio component, video component, or other perceivable media component, by the computing device, synchronized with the rendering by the remote media player within in the perceptible distance of the user includes sampling one or more of the audio component, video component, or other perceivable media component of the multimedia content being rendered by the remote media player within the perceptible distance of the user; determining a timing difference between samples of one or more of the audio component, video component, or other perceivable media component of the multimedia content being rendered and the audio component, video component, or other perceivable media component obtained from the source of the multimedia content; rendering the selected one of the audio component, video component, or other perceivable media component by the computing device so that the user will perceive the selected one of the audio component, video component, or other perceivable media component so rendered to be synchronized with the multimedia content rendered by the remote media player.

Example 12. The method of any one of examples 1-11, in which the computing device is an enhanced reality (XR) device.

A number of different cellular and mobile communication services and standards are available or contemplated in the future, all of which may implement and benefit from the various aspects. Such services and standards may include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020TM), EDGE, advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), integrated digital enhanced network (iDEN), C-V2X, V2V, V2P, V2I, and V2N, etc. Each of these technologies involves, for example, the transmission and reception of voice, data, signaling, and/or content messages. It should be understood that any references to terminology and/or technical details related to an individual telecommunication standard or technology are only for illustrative purposes and are not intended to limit the scope of the claims to a particular communication system or technology unless specifically recited in the claim language.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A method, for multi-source multimedia output and synchronization in a computing device, comprising:
receiving a user input selecting one of an audio component, video component, or other perceivable media component associated with multimedia content being rendered by a remote media player within in a perceptible distance of a user of the computing device, wherein the user input indicates that the user wants the selected one of the audio component, video component, or other perceivable media component rendered on the computing device;
identifying, by a processor of the computing device, the multimedia content;
obtaining the identified multimedia content from a source of the multimedia content; and
rendering the selected one of the audio component, video component, or other perceivable media component from the obtained multimedia content, by the computing device, synchronized with the rendering by the remote media player within the perceptible distance of the user.

2. The method of claim 1, wherein the multimedia content is selected by the user from a plurality of multimedia content observable by the user.

3. The method of claim 1, wherein receiving a user input comprises:
detecting a gesture performed by the user;
interpreting the detected gesture to determine whether it identifies the multimedia content being rendered within a threshold distance of the computing device; and
identifying one of the audio component, video component, or other perceivable media component of the identified multimedia content that the user wants rendered on the computing device.

4. The method of claim 1, wherein identifying the multimedia content that is being rendered on a display within a perceptible distance of the user of the computing device comprises:
detecting a gaze direction of the user; and
identifying the multimedia content that is being rendered on the display in the direction of the user's gaze.

5. The method of claim 4, wherein identifying multimedia content that is being rendered on the display within a perceptible distance of a user of the computing device comprises:
receiving a user input indicating a direction from which the user is perceiving the multimedia content; and
identifying the multimedia content based on the received user input.

6. The method of claim 1, wherein obtaining the identified audio component, video component, or other perceivable media component of the multimedia content from a source of the multimedia content comprises:
obtaining metadata regarding the multimedia content;
using the obtained metadata to identify a source of the multimedia content; and
obtaining the audio component, video component, or other perceivable media component from the identified source of the multimedia content.

7. The method of claim 1, wherein obtaining the identified audio component, video component, or other perceivable media component of the multimedia content from a source of the multimedia content comprises:
transmitting a query to a remote computing device regarding the multimedia content;
requesting identification of a source of the multimedia content; and
obtaining the audio component, video component, or other perceivable media component from the identified source of the multimedia content.

8. (canceled)

9. (canceled)

10. The method of claim 1, wherein obtaining the identified multimedia content from a source of the multimedia content comprises:
obtaining subscription access to the multimedia content from the source of the multimedia content; and
receiving the identified audio component, video component, or other perceivable media component of the multimedia content based on the obtained subscription access.

11. The method of claim 1, wherein rendering the selected one of the audio component, the video component, or other perceivable media component, by the computing device, synchronized with the rendering by the remote media player within in the perceptible distance of the user comprises:
sampling one or more of the audio component, video component, or other perceivable media component of the multimedia content being rendered by the remote media player within the perceptible distance of the user;
determining a timing difference between samples of one or more of the audio component, video component, or other perceivable media component of the multimedia content being rendered and the audio component, video component, or other perceivable media component obtained from the source of the multimedia content; and
rendering the selected one of the audio component, video component, or other perceivable media component by the computing device so that the user will perceive the selected one of the audio component, video component, or other perceivable media component so rendered to be synchronized with the multimedia content rendered by the remote media player.

12. (canceled)

13. A computing device, comprising:
a transceiver; and
a processor coupled to the transceiver and configured to:
receive a user input selecting one of an audio component, video component, or other perceivable media component associated with multimedia content being rendered by a remote media player within in a perceptible distance of a user of the computing device, wherein the user input indicates that the user wants the selected one of the audio component, video component, or other perceivable media component rendered on the computing device;
identify the multimedia content;
obtain the identified multimedia content from a source of the multimedia content; and
render the selected one of the audio component, video component, or other perceivable media component from the obtained multimedia content, by the computing device, synchronized with the rendering by the remote media player within the perceptible distance of the user.

14. The computing device of claim 13, wherein the processor is configured such that the multimedia content is selected by the user from a plurality of multimedia content observable by the user.

15. The computing device of claim 13, wherein the processor is further configured to receive a user input by:
detecting a gesture performed by the user;
interpreting the detected gesture to determine whether it identifies the multimedia content being rendered within a threshold distance of the computing device; and
identifying one of the audio component, video component, or other perceivable media component of the identified multimedia content that the user wants rendered on the computing device.

16. The computing device of claim 13, wherein the processor is further configured to identify the multimedia content that is being rendered on a display within a perceptible distance of the user of the computing device by:
detecting a gaze direction of the user; and
identifying the multimedia content that is being rendered on the display in the direction of the user's gaze.

17. The computing device of claim 16, wherein the processor is further configured to identify multimedia content that is being rendered on the display within a perceptible distance of a user of the computing device by:
receiving a user input indicating a direction from which the user is perceiving the multimedia content; and
identifying the multimedia content based on the received user input.

18. The computing device of claim 13, wherein the processor is further configured to obtain the identified audio component, video component, or other perceivable media component of the multimedia content from a source of the multimedia content by:
obtaining metadata regarding the multimedia content;
using the obtained metadata to identify a source of the multimedia content; and
obtaining the audio component, video component, or other perceivable media component from the identified source of the multimedia content.

19. The computing device of claim 13, wherein the processor is further configured to obtain the identified audio component, video component, or other perceivable media component of the multimedia content from a source of the multimedia content by:
transmitting a query to a remote computing device regarding the multimedia content;
requesting identification of a source of the multimedia content; and
obtaining the audio component, video component, or other perceivable media component from the identified source of the multimedia content.

20. The computing device of claim 19, wherein the processor is further configured to:
sample one of the audio component or video component being rendered by the remote media player, wherein the transmitted query includes at least a portion of the sampled one of the audio component or video component.

21. The computing device of claim 19, wherein the processor is further configured to identify the source of the multimedia content or synchronize the rendering by the remote media player based on information received in response to the transmitted query.

22. The computing device of claim 13, wherein the processor is further configured to obtain the identified multimedia content from a source of the multimedia content by:
obtaining subscription access to the multimedia content from the source of the multimedia content; and
receiving the identified audio component, video component, or other perceivable media component of the multimedia content based on the obtained subscription access.

23. The computing device of claim 13, wherein the processor is further configured to render the selected one of the audio component, the video component, or other perceivable media component, by the computing device, synchronized with the rendering by the remote media player within in the perceptible distance of the user by:
sampling one or more of the audio component, video component, or other perceivable media component of the multimedia content being rendered by the remote media player within the perceptible distance of the user;
determining a timing difference between samples of one or more of the audio component, video component, or other perceivable media component of the multimedia content being rendered and the audio component, video component, or other perceivable media component obtained from the source of the multimedia content; and
rendering the selected one of the audio component, video component, or other perceivable media component by the computing device so that the user will perceive the selected one of the audio component, video component, or other perceivable media component so rendered to be synchronized with the multimedia content rendered by the remote media player.

24. -30. (canceled)
